(19) United States
(12) Patent Application Publication
(10) Pub. No.: US 2008/0256648 A1
(43) Pub. Date: Oct. 16, 2008

(54) Secure portable computer and security method

(76) Inventors: Gregory A. Piccionelli, Westlake Village, CA (US); Michael M. Gerardi, Menifee, CA (US)

Correspondence Address: Michael M. Gerardi, Suite 200, 2801 Townsgate Road, Westlake Village, CA, 91361, US

(21) Appl. No.: 12/157,942

(22) Filed: Jun. 13, 2008

Related U.S. Application Data
(63) Continuation of application No. 10/822,153, filed on Apr. 9, 2004.
(60) Provisional application No. 60/462,367, filed on Apr. 11, 2003.

(51) Int. Cl. G06F 21/00

(52) U.S. Cl. 726/35

(57) ABSTRACT

A computer includes a processor, position determining means for determining the location of the computer, and control means for controlling the operation of the processor. The control means are in communication with the position determining means and control the operation of the processor in response to location information provided to the control means by the position determining means.

This application is a continuation of U.S. patent application Ser. No. 10/822,153, filed Apr. 9, 2004, which in turn was based on U.S. Provisional Patent Application Ser. No. 60/462,367, filed April 11, 2003, the entire disclosures of each of which are incorporated herein by reference.

### FIELD OF THE INVENTION

The present invention relates to a system for discouraging the unauthorized transport of a computer, more specifically a portable computer, and preventing the use of computers so transported, and to methods employing such systems.

### BACKGROUND OF THE INVENTION

Portable computers, such as notebooks and laptops, have proven very popular and have led to increased productivity by freeing users from the need to utilize the computers at specific locations, such as offices. Work can now be accomplished, for example, on airplanes, ships, trains, and buses, as well as in hotel rooms, cafes, libraries, bookstores and the like.

However, the very portability of such computers gives rise to security problems. Since the computers are readily moved, and also easily stored, and thus concealed, in briefcases, suitcases and the like, they are vulnerable to unauthorized use and also theft.

A need exists for a computer, more particularly a portable computer, that is secure against theft and unauthorized use, in particular use in unauthorized locations.

A need also exists for a method of deterring the unauthorized transport and use of a computer, more particularly a portable computer.

### SUMMARY OF THE PREFERRED EMBODIMENTS

In accordance with one aspect of the present invention, there is provided a computer that includes a processor, position determining means for determining the location of the computer, and control means for controlling the operation of the processor. The control means is in communication with the position determining means and controls the operation of the processor in response to location information provided to the control means by the position determining means.

More specific embodiments further include input means for providing location information to the control mean, for example a keyboard, a diskette drive, or the like. The location information defines at least one location in which use of the computer is authorized.

More specific position determining means include, for example, GPS locaters and accelerometers.

In particular embodiments, the control means prevents operation of the processor in response to location information provided by the position determining means that indicates that the location of the computer is not a location in which use of the computer is authorized.

In other particular embodiments, the computer further includes a hard drive in communication with the processor. In certain of these embodiments, the control means instructs the processor to prevent operation of the hard drive in response to location information provided by the position determining means that indicates that the location of the computer is not a location in which use of the computer is authorized. In certain other of these embodiments, the control means instructs the processor to at least partially erase the hard drive when the computer is determined to be in an unauthorized location.

In additional particular embodiments, the computer further includes alarm means for transmitting an alarm to a preselected destination. The alarm means is in communication with the processor. The control means instructs the processor to generate an alarm using the alarm means when it is determined that the computer is in an unauthorized location.

In still other particular embodiments, the computer also includes identification means for identifying an authorized user. The identification means is in communication with the processor. Such identification means can include, for example, facial recognition means such as video cameras, input devices such as keyboards, etc. In such embodiments, upon determination that the computer is not in a location in which its use is authorized, the control means instructs the processor to request identification of a user attempting to use the computer. If proper identification is provided, the computer functions as normal. If proper identification is not provided, the control means alters the normal operation of the computer, for example in a manner described above such as prevention of further operation of the processor and/or hard drive, issuance of an alarm, etc.

According to another aspect of the present invention, methods for controlling the use of a computer are also provided. A computer as described above is provided, and location information is supplied to the computer defining at least one location in which use of the computer is authorized.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a schematic diagram of an embodiment of a computer according to the present invention which includes a processor, position determining means and control means, and further includes keyboard input means,

FIG. 2 is a schematic diagram of a more particular embodiment that includes a hard drive,

FIG. 3 is a schematic diagram of another more particular embodiment that includes alarm means,

FIG. 4 is a schematic diagram of a further particular embodiment that includes a facial recognition device,

FIG. 5 is a flowchart illustrating a method of controlling the use of a computer as described herein, in which normal operation of the computer is altered upon a determination that the location of the computer is not a location in which use of the computer is authorized, and

FIG. 6 is a flowchart illustrating an alternative method in which authorization is requested from a user when the location of the computer is determined to be a location in which use is not presently authorized.

In the figures, like numbers are used to denote like elements throughout.

### DETAILED DESCRIPTION OF THE PREFERRED EMBODIMENTS

As used herein, the term “computers” denotes any digital processing device, whether independently usable, such as a laptop or notebook computer, a personal computer (PC), a PDA, and the like, or embedded within another portable or non-portable device, such as an appliance, an automobile, etc.

Turning to FIG. 1, a first embodiment of a computer 10 according to the present invention includes a processor 12, position determining means 14 in communication with the processor 12, and control means 16 in communication with processor 12 and with position determining means 14. Input device 18, as shown in FIG. 1 a keyboard, is also provided.

Position determining means 14 can be, in particular embodiments, a GPS locator. In other particular embodiments, position determining means 14 can include an accelerometer which continually records accelerations (including the direction of each acceleration) and thus can be used to determine distances and directions in which the computer moves with respect to its initial location. Other position determining devices can also be incorporated in place of, or in addition to, the foregoing exemplary devices.

Position determining means 14 desirably is maintained in continuous operation, by means of an independent power supply or by the computer's power supply. This enables continuous determination of the location of the computer. In other embodiments, more specifically embodiments using a GPS locator, position determining means 14 can be powered on when the computer 10 itself is powered on. Upon powering on, position determining means 14 determines the location of the computer.

Position determining means 14 produces an output upon determining the location of the computer (which output can be continuously or discontinuously generated). This output, i.e., location information, is then provided to control means 16.

Control means 16, in particular embodiments, includes one or more semiconductor devices that are responsive to location information provided by position determining means 14. Control means 16, in specific embodiments, is adapted to receive location information by means of an input device (for example, a keyboard, diskette drive or other means). In alternative embodiments, location information defining one or more locations in which use of the computer is authorized can be provided in the form of a ROM chip or other solid state device incorporated into control means 16. The locations so defined can be single points, such as a specific office or other workplace, or a particular area defined by GPS coordinates or other similar data. Multiple authorized locations can be provided to control means 16 as desired.

As illustrated in the figures, processor 12, position determining means 14 and control means 16 comprise discrete individual devices. However, the invention is not limited to embodiments in which these elements are discrete. Some or all of these elements can be combined into a single device, for example a semiconductor device, if desired.

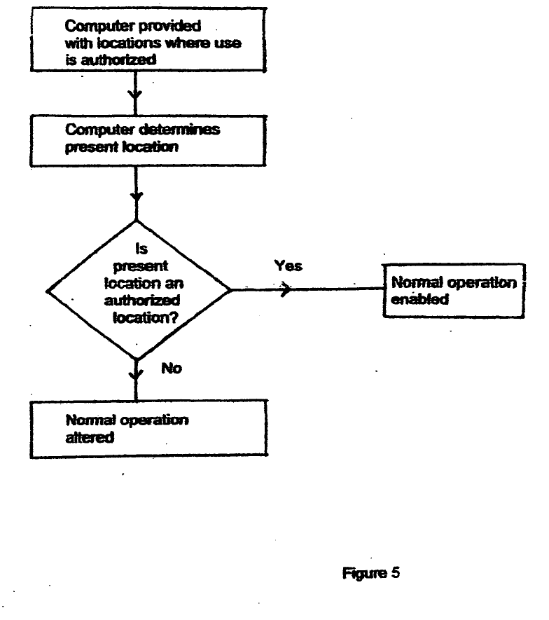

In operation (see FIG. 5), position determining means 14 determines the present location of the computer 10, and provides the location information so determined to control means 16. Control means 16 then determines whether the present location of the computer 10 corresponds to a location in which its use is authorized. If the present location is an authorized location, controller 16 enables the normal operation of the computer. However, if the present location is not an authorized location, control means 16 alters the normal operation of the computer. Particular embodiments of altered operation of the computer are described below.

In the embodiment shown in FIG. 1, control means 16 prevents operation of the processor 12 when it is determined that the location of the computer is not a location in which use of the computer is authorized.

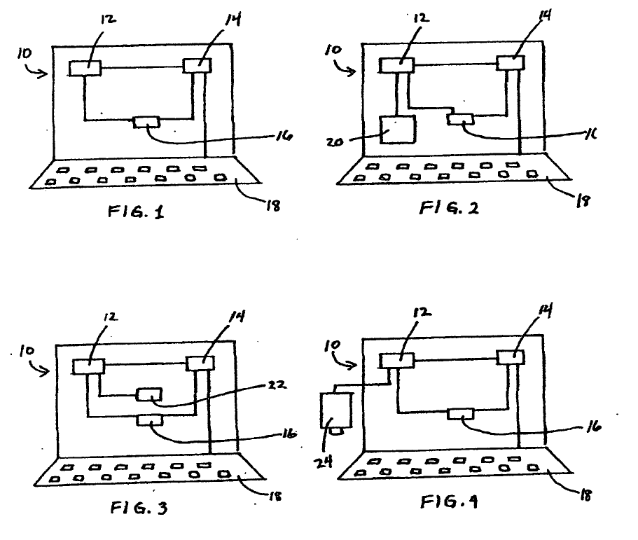

In FIG. 2, computer 10 further includes hard drive 20 in communication with processor 12. In certain specific embodiments, control means 16 instructs the processor 12 to prevent operation of the hard drive 20 when the portable computer is determined to be in an unauthorized location. This instruction can be accomplished directly by the control means 16. That is, control means 16 can instruct processor 12 to cease functioning. Alternatively, control means 16 can pass on the location information from position determining means 14 to processor 12. Processor 12 then responds to the location information and ceases operation. In such embodiments, control means 16 and processor 12 essentially form a single combined element.

In other specific embodiments, control means 16 instructs processor 12 to erase some or all of the contents of hard drive 20.

Alternative embodiments provide for direct communication between the hard drive 20 and control means 16, and enable control means 16 directly to disable or erase hard drive 20.

The embodiment illustrated in FIG. 3 further includes alarm means 22 in communication with processor 12. Alternative embodiments provide for direct communication between control means 16 and alarm means 22, as described above in connection with FIG. 2. In either embodiment, alarm means 22, upon instruction from processor 12 and/or control means 16, generates an alarm when the computer is determined to be in an unauthorized location. This alarm can be an audible alarm generated by the computer itself, in particular embodiments. In other embodiments, the alarm can be transmitted to an external site, such as a police station, security service or other location.

The foregoing embodiments function to prevent or otherwise alter the normal operation of the computer in unauthorized locations. However, it may be desirable to permit operation of the computer in locations Which have not previously been authorized, provided that the person attempting to use the computer at such a site is authorized to do so. The embodiment illustrated in FIG. 4 facilitates such use.

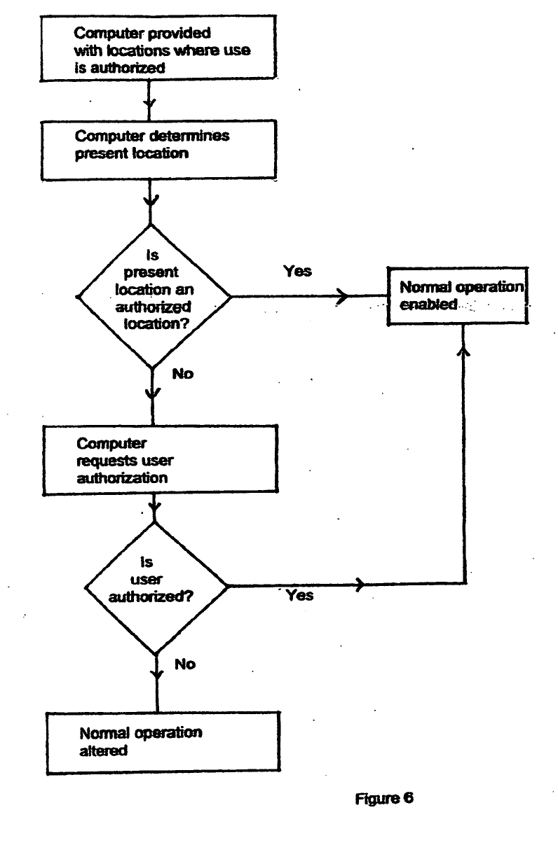

In FIG. 4, the computer 10 further includes identification means for identifying a user, which serve to verify that the user is authorized to use the computer. As shown, a facial recognition device 24, for example a small video camera attached to computer 10, is in communication with processor 12. When control means 16 determines that the present position of computer 10 is not an authorized location, it causes processor 12 to request identification of the user. In the illustrated embodiment, video camera 24 scans the face of the user and provides the scanned image to processor 12 for comparison with a database of authorized users' faces. Alternatively, the facial data can be provided to control means 16 for comparison with a database stored therein. In either event, comparison of the facial features of the user with the database of authorized users establishes whether or not the user is authorized to use the computer. As illustrated in FIG. 6, if the user is found to be an authorized user, normal computer operation is enabled. Otherwise, normal computer operation is altered, for example in a manner as described above.

In alternative embodiments, user identification can be provided via a keyboard or other input device. For example, the user can be requested to provide an authorization code. If the proper code is input, normal operation of the computer is enabled. If the user fails to supply the proper code, normal operation of the computer is altered, as discussed above.

A further embodiment makes use of an element that broadcasts the position (e.g., the GPS coordinates) of the authorized user(s) of a computer. Such an element can be included in a cellular telephone, for example, a PDA, a watch, a ring, etc., or can be an implanted element such as a subcutaneous chip implant. In such embodiments, the position-broadcasting element is provided with the GPS coordinates or other position indicia (either from a separate position-determining element or from a position-determining element with which the position broadcasting element is combined, i.e., on the same chip). The position-broadcasting element then broadcasts the position of the authorized user to the computer the user is authorized to use. The computer compares the position of the user as provide by the user's position-broadcasting element and determines the distance between the computer and the user. If the computer is in use, or subsequently becomes in use, when the distance between the computer and the user exceeds a preselected maximum distance, the computer's control means controls the operation of the computer in a manner described herein. That is to say, when the distance between the computer and the authorized user exceeds the maximum distance, the computer concludes that authorized user is no longer in the same position as the computer, and thus that use of the computer is unauthorized.

In a variant of the foregoing embodiment, the computer includes an additional element that provides a request for identification from a position-broadcasting element borne by the authorized user(s), i.e., pings the user. Upon receipt of the ping, the user's position-broadcasting element obtains the user's position and broadcasts it to the computer for distance determination as described above.

According to further embodiments, in the event of unauthorized use of the computer, the computer continues functioning for a period of time sufficient to obtain an image of the unauthorized user (e.g., by recording information obtained from a facial recognition device as described herein) and recording the image and/or transmitting the image to a security organization, police department, etc., prior to generation of an instruction to prevent operation of the computer's processor.

Still other particular embodiments make additional use of “pinging”. In certain specific embodiments, the computer, upon detecting unauthorized use, broadcasts a request for identification from near-by computer chips (such as those described above which may be present in cellular phones, PDA's, etc.) that may be present, in order to identify potential unauthorized users.

Other specific embodiments are beneficially implemented in the case in which the computer's position determining means have been disabled. These embodiments rely on the presence of a “security entry door” that a cellular telephone company, PDA manufacturer, etc., provides for the implementation of a computer security method as described herein. The security entry door is accessible by broadcast means included in or associated with the computer when the computer makes use of a specific “key” or code.

In such embodiments, when the computer determines that it has been moved or otherwise used without authorization, and in more specific embodiments when its position-determining means are disabled, the computer attempts to access, e.g., an adjacent cellular telephone through its security entry door by broadcasting the key. If a cellular telephone having the requisite security entry door is present within range of the computer, the computer then accesses the cellular telephone and uses it to transmit to a security agency, police department or other authority a message advising that it has been stolen or otherwise put to unauthorized use. That is, the computer commandeers an adjacent cellular telephone in order to transmit the message.

To prevent abuse of such cellular telephones or other devices as spying or tracking systems, particular embodiments of the foregoing method only permit brief transmissions of encrypted location information, together with the message, for a brief period of time, such as one second. Furthermore, such embodiments preferably do not transmit the identification of the cellular telephone or other device being used to transmit the information.

What is claimed is:

1. A computer comprising a) a processor, b) position determining means for determining the location of the computer, and c) control means for controlling the operation of the processor, the control means being in communication with the position determining means and controlling the operation of the processor in response to location information provided to the control means by the position determining means.

2. The computer of claim 1 wherein the position determining means comprise a GPS locator.

3. The computer of claim 1 wherein the position determining means comprise an accelerometer.

4. The computer of claim 1 wherein the control means prevents operation of the processor in response to location information provided by the position determining means that indicates that the location of the computer is outside of a preselected area.

5. The computer of claim 1 further comprising a hard drive in communication with the processor.

6. The computer of claim 5 wherein the control means instructs the processor to prevent operation of the hard drive in response to location information provided by the position determining means that indicates that the location of the computer is outside of a preselected area.

7. The computer of claim 5 wherein the control means instructs the processor to at least partially erase the hard drive in response to location information provided by the position determining means that indicates that the location of the computer is outside of a preselected area.

8. The computer of claim 1 further comprising alarm means for transmitting an alarm to a preselected destination, the alarm means being in communication with the processor.

9. The computer of claim 8 wherein the control means instructs the processor to generate an alarm using the alarm means in response to location information provided by the position determining means that indicates that the location of the computer is outside of a preselected area.

10. The computer of claim 1 further comprising identification means for identifying an authorized user, the identification means being in communication with the processor.

11. The computer of claim 10 wherein the control means instructs the processor to request identification of a user by using the identification means in response to location information provided by the position determining means that indicates that the location of the computer is outside of a preselected area.

12. The computer of claim 11 wherein the identification means is a facial recognition device that identifies a user as an authorized user by reference to a data base of facial features associated with one or more authorized users.

13. The computer of claim 11 wherein the identification means is in communication with an input device and identifies the user as an authorized user upon input by the user of an authorization code.

14. The computer of claim 11 wherein the control means prevents further operation of the processor upon failure of the identification means to identify the user as an authorized user.

15. The computer of claim 11 further comprising a hard drive in communication with the processor.

16. The computer of claim 15 wherein the control means instructs the processor to prevent operation of the hard drive upon failure of the identification means to identify the user as an authorized user.

17. The computer of claim 15 wherein the control means instructs the processor to at least partially erase the hard drive upon failure of the identification means to identify the user as an authorized user.

18. The computer of claim 11 further comprising alarm means for transmitting an alarm to a preselected destination, the alarm means being in communication with the processor.

19. The computer of claim 18 wherein the control means instructs the processor to generate an alarm using the alarm means upon failure of the identification means to identify the user as an authorized user.

20. The computer of claim 1 which is a portable computer.
